(19) United States
(12) Patent Application Publication
(10) Pub. No.: US 2004/0248718 A1
(43) Pub. Date: Dec. 9, 2004

(54) Candy box construction and method

(76) Inventor: Steven W. Stanton, Venice, CA (US)

Correspondence Address: Lawrence S. Cohen, Suite 1220, 10960 Wilshire Boulevard, Los Angeles, CA, 90024, US

(21) Appl. No.: 10/456,036

(22) Filed: Jun. 5, 2003

(51) Int. Cl. B31B 1/62

(52) U.S. Cl. 493/150

(57) ABSTRACT

A method of making a candy box by creating a glue fillet in the corner defined by the side and an inside closure member and placing an outside closure member over the inside closure member in which the glue is injected by an injector that is controlled to aim the glue into the corner to get a good glue fillet.

### FIELD OF THE INVENTION

The invention relates to decorative boxes in particular to a decorative box and a method of making a decorative box of the type made from paper products and in further particular relating to candy boxes

### BACKGROUND OF THE INVENTION

Typically decorative boxes such as candy boxes are made of a paper board material and are covered with decorative paper. They comprise a box body having a side element and a closure at the bottom, and a cover with a side element and a closure at the top. The sides are formed with bends, corners and the closures conform to the shape of the sides. Covers may be fully removable or hinged in some manner such as by a paper hinge. Boxes vary in durability and purpose; the strength of the materials and the construction method used varies depending on the desired durability and purpose. To form corners, the structural element may be scored and bent to define a sharp corner. To form curves the structural element is bent into a curve of the desired shape without exceeding the bending strength of the material. Usually the ends of a continuous side element will meet at a place where there is to be a corner or sharp turn in the shape.

A particular field of boxes is candy boxes. These are made to survive the journey to the customer (subject to careful handling) with their decorative features intact and from then only need to last a short time until the candy is consumed. The particular materials and ruggedness of construction required for candy boxes is well known in the field. An especially popular type of candy box is the heart shaped box used in great quantities for the Valentines Day holiday.

Cost is an important factor which is manifest in both the material cost and the labor cost including the adaptation of automation to make the boxes.

Typically the structural elements will be glued together; although it is possible to join the elements by means of a decorative paper cover extending from one structural element to the other. Sometimes both means are used, together.

In a large box of this type, greater strength is needed in joining the structural elements such as the side element and the bottom closure. Also, some boxes shapes have portions of the side element bent inwardly convexly or concavely to form a shape. This bending inwardly creates a tendency to straighten, that is to unbend. Therefore there is a need to have a construction and method, which will strongly hold all the parts together against the tendency to straighten.

One solution to this problem is seen in U.S. Pat. No. 5,400,917. In that patent there is disclosed a three layer bottom closure assembly for the bottom of the box, which can also be used for the box cover. The exterior layer of the three layers is made of lightweight board suitable for the desired appearance and strength of the box. The interior layer is also made of lightweight board. The glue problem is to provide enough area of contact of a glue bead between the side member and the two layers that comprise interior and exterior layers. By inserting a spacer between the exterior layer and the interior layer, the spacer being slightly smaller or scalloped around its edges a space or channel to receive glue is provided. This provides for an extended area of glue contact on the side member due to the thickness of the spacer and also an extended area of glue contact with the inner and outer members due to the space created by the reduced size or scalloping of the spacer.

It would be of considerable benefit if the requisite glue contact could be accomplished consistently over large volumes of box manufacture without the enlargement and extra cost (both materials and labor) caused by the spacer. The present invention provides a solution to the problem of strong glue contact without use of a spacer and allows automation for high volume production.

### SUMMARY OF THE INVENTION

A candy box or a candy box cover is constructed with use of a fixture and glue injector by placing a side member in a fixture to form the shape of the box, placing an inner closure element inside the space defined by the side member and directing a glue injector around the interior angle formed by the side member and the inner closure member so as to create a glue fillet in contact with both the side member and the inner closure element. Then an outer closure element is placed over the inner closure element and slight controlled pressure is applied to compress the glue fillet so that a sufficient area of glue contact is established with both the side element and the two closure elements (the two closure elements together define a closure assembly).

In another embodiment movement of the glue injector is controlled by a machine designed or programmed to maintain, to the extent possible, an angle of the glue injector for injection of glue to provide a glue fillet in a substantial portion of the interior angle.

If the angle between the side element and the closure assembly is 90°, as is very common, the desired angle is 45° plus or minus 20° and more preferably plus or minus 10°.

In another embodiment the machine is a programmable six axis machine for controlling movement of the glue injector.

In another embodiment the amount of glue injected is controlled to leave a glue layer after assembly and curing of the glue of a thickness of about twice the sum of the thickness of the inner and outer closure elements.

In another embodiment the angle for injection is allowed to vary from the middle of the interior angle by plus or minus about 20° and more preferable by plus or minus about 10°.

In another embodiment the glue injection is begun at a point on the inner closure element away from the intersection of the side element and the inner closure element and is then directed into the interior corner defined by the side element and the closure assembly.

In another embodiment the amount of glue injected is controlled to leave a glue layer after assembly and curing of the glue of the outer closure element of a width of at least about twice the sum of the thickness of the inner and outer closure elements.

In another embodiment the box and its cover are heart shaped and glue injection is begun near the point of the heart and the injector is directed into the interior corner a selected distance away from the point of the heart and the injection of glue is terminated a selected distance away from the point of the heart.

In another embodiment the amount of glue injected is controlled to leave a glue layer after assembly and curing of the glue of a width at least about three times the sum of the thickness of the inner closure element and the outer closure element.

### BRIEF DESCRIPTION OF DRAWINGS

FIG. 1 shows the prior art.

FIG. 2 shows the step of injecting glue.

FIG. 3a shows a pattern of injected glue in a heart box construction.

FIG. 3b shows an alternative pattern of glue injection in a heart box construction.

FIG. 4 shows the step of placing the outside closure member

FIG. 5 shows an alternative form.

FIGS. 6a and 6b are schematic representations of glue injector angles

### DETAILED DESCRIPTION

The content of U.S. Pat. No. 5,400,917 is incorporated by reference into this description. Although some of the wording used here to describe various parts and steps may be different from that used in the '917 patent, those skilled in the art will recognize the intended meanings and the commonality and distinctions.

FIG. 1 shows how the prior art configuration and method works. A side element 10 is fitted around a fixture 12 and an inner closure element 14 is placed inside it on the fixture surface 15. Then a spacer 16 is placed on top of the inner closure element creating a channel 18. A glue injector 20 can be aimed at the channel and moved around the inside periphery of the box to fill the channel with glue. It is sufficient for this procedure to provide the glue injector 20 with movement in which it is always pointing straight downward. As described in the '917 patent this will provide a good glue attachment of the parts of the box because the spacer allows a sufficient amount of glue to bind to both the side element and the closure elements. With the spacer 16 in place the required control of the injector 20 is reduced because the glue only has to flow into the channel 18.

It is an important goal of the prior art and the present invention to get wide glue contact on the side element and on the inner closure element simultaneously. In the present invention this accomplished by depositing a glue fillet at the corner formed by the side element and the inner closure element. The optimum glue fillet is approximately symmetrical, that is, the contact area on the side element and on the inner closure element is about the same.

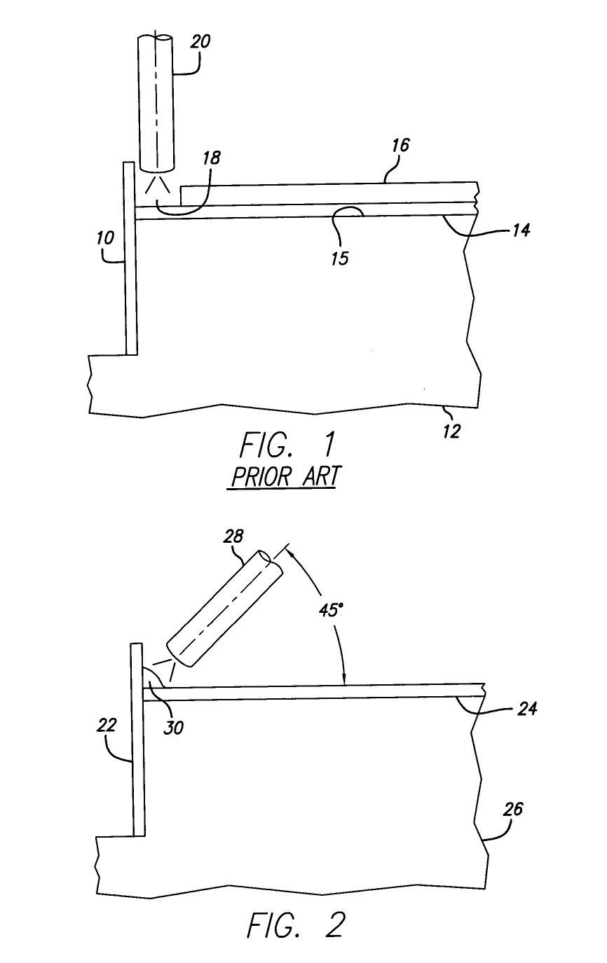

FIG. 2 shows a side element 22 and an inner closure element 24 mounted in a fixture 26. A glue injector 28 is directed at the interior corner formed by the side element 22 and the inner closure element 24 so that the injected glue forms a fillet 30. The glue injector 28 is directed at an angle that is about one-half the angle formed between the side element 22 and the inner closure element 24. Most of the time the angle between the side element 22 and the inside closure element 24 is 90 degrees, so the desired angle of the glue injector 28 will be about 45° from vertical (or horizontal), where, as in this embodiment, the elements are vertical and horizontal respectively.

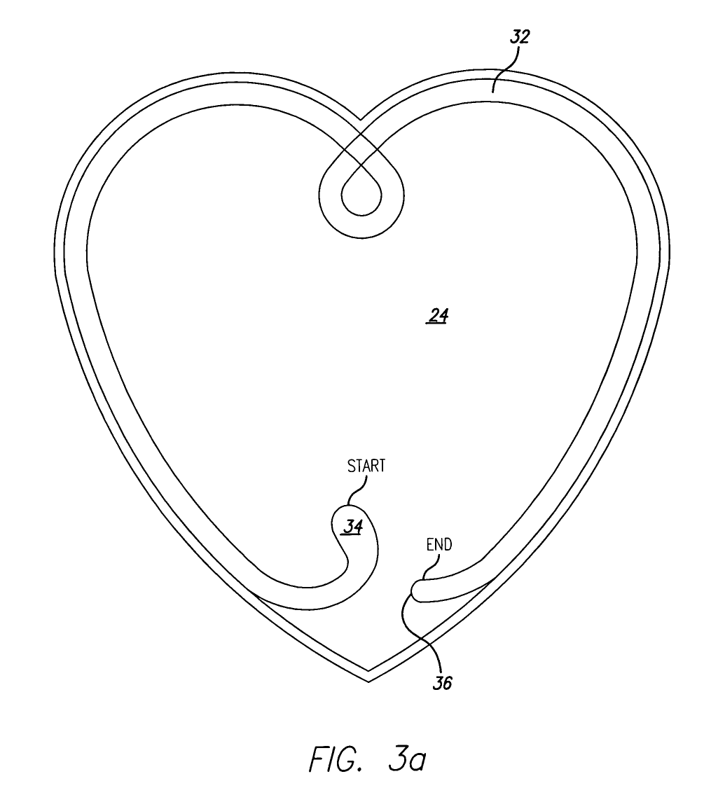

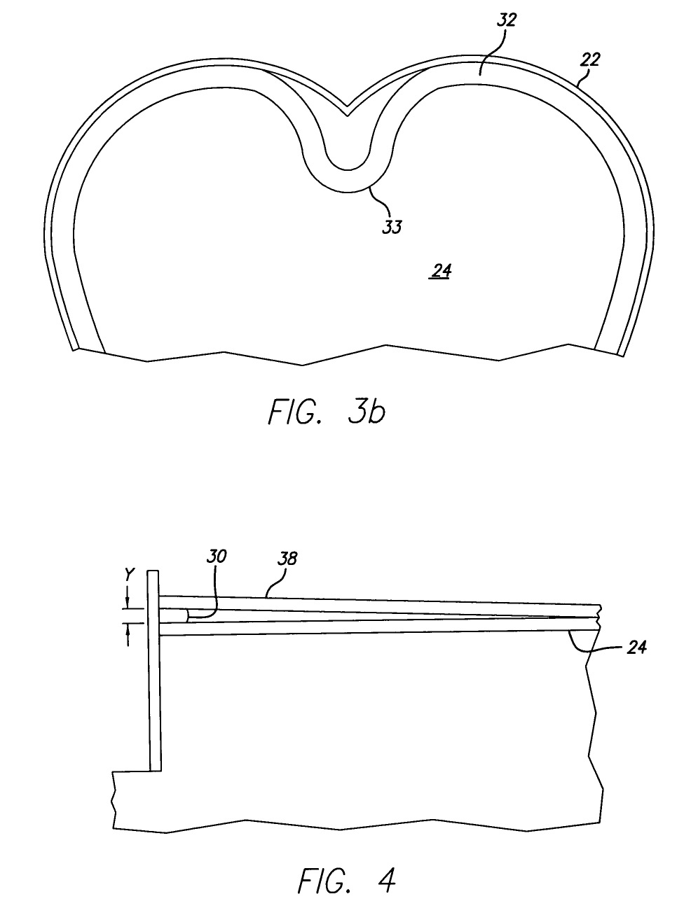

FIG. 3a shows a programmed glue injection pattern 32 for a heart shaped candy box having side element 22 and an inner closure element 24. The glue injection starts at 34 and ends at 36 which are both on the inner closure element 24 and spaced away from the interior corner. This is because at the start 34 of glue injection a larger amount of glue is deposited because the injector apparatus initially is not stabilized to the desired combined glue flow rate and injector movement. After stabilized glue flow is established the injector 28 moves to the interior corner and procedes around the inner periphery. As seen in FIG. 3a at the intersection of the heart lobes the glue injector is moved through a circle because the machine cannot make a point turn while maintaining movement of the injector to keep the flow uniform, it has pause or slow down. At the end 36 there is also an enlarged blob of glue, for the same reason as the injector 28 stops. An alternative flow path is shown in FIG. 3b in which the glue injector follows a curved path 33 around the intersection of the heart lobes. For heart shaped candy boxes the crest of the heart lobes is a critical area because they tend to lift if not glued firmly and in particular if the glue does not set sufficiently before pressure is released.

The next step is to lay an outside closure element with controlled pressure on top of the inside closure element, compressing the glue fillet. The amount of compression on the glue fillet should be enough to flatten it so that there is a height (also called thickness) of glue contacting the side element at least equal to the thickness of the outer closure element. For most candy box sizes this means that the height of the glue on the side element after the outer closure element is laid down ranges from about one sixteenth inch to about one thirty-second inch. It is also best that the outer closure element be laid down by vertical placement, preferable not by rolling placement.

FIG. 4 shows an outer closure element 38 set down on top of the inner closure element 24 and compressing the glue fillet 30. A common glue thickness for fairly small size candy boxes is 0.020 in (about 1/32 in), that is, the desired height Y is about 1/32 in.

For larger boxes, it is desirable that the height of glue contact with the side element be about equal to the sum of the thickness of the inner closure element and the outer closure element.

Also, it is desirable that the width of the glue contact with the closure elements be at least about three times the sum of the thickness of the inner and outer closures.

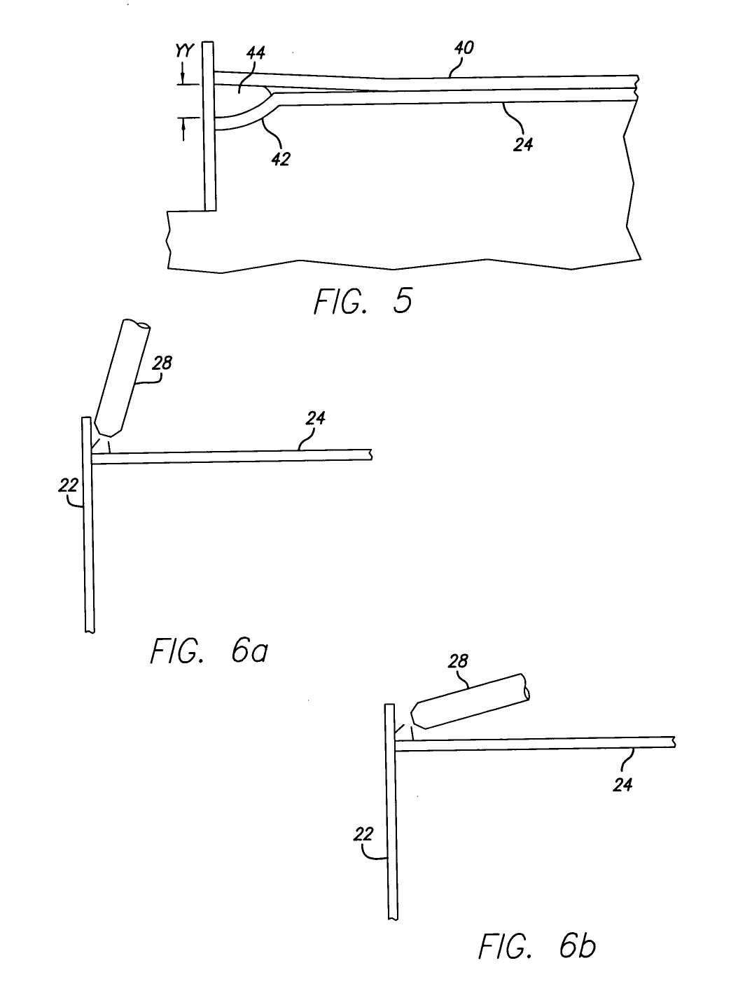

FIG. 5 shows an alternative configuration for use where a greater height of glue contact on the side element 22 is desired. In this case the inner closure element 40 is embossed around its periphery as at 42 to bend it away from the outer closure element 24. This creates a higher space YY so that the height of glue adhered to the side element 22 is greater. The embossment can be placed around the outer closure element but this would show on the exterior of the box and so is regarded as less desirable, although functionally it would work just as well.

In a preferred embodiment, to accomplish control of the glue injector, it is installed on a robotic device that has six axes of movement. A SV3 JRC Six Axis Robot coupled with a JRC Enhanced Teach Pendant made (or assembled and programmed) by MOTOMAN a Yaskawa company of West Carrollton, Ohio does the job nicely. This is implemented with WINCAPS Lite Software for efficient program development and management. However it is not necessarily the case that a six-axis device be used. A lesser number of axes of movement may suffice. The essential capability is to be able to keep the glue injector aimed into the interior corner formed by the side element and the inner closure element to form a good glue fillet. A good glue fillet is one that will retain its shape, that is, it will not flow before the outer closure element is installed. A glue fillet that is of equal height and length, that symmetrical, is understood to define a good glue fillet. This is accomplished by controlling the angle of the glue injector. In the case of 90-degree corners, which is nearly all of the cases, the 45-degree angle is the optimum. But a good glue fillet can be formed at 10° more or less from the 45° angle, and satisfactory glue fillet can be formed at 200 more or less from the 45° angle.

In the more general case, optimally, the glue injector should be directed at an angle that splits the angle formed between the side element and the inside closure element. If the actual angle is greater than 90 degrees, then an even greater divergence from the halfway angle can be used and still get a good glue fillet. But when the actual angle is smaller than 90 degrees the allowable range is decreased for the divergence toward vertical, although not for the divergence toward horizontal. Those skilled in the art will also appreciate that the size of the glue injector along with its proximity to the interior corner will play a role in the allowable angle of injection limiting the range of angle if it is so large as to interfere with the elements of the box.

Further the allowable divergence of the angle toward horizontal is greater than that toward vertical. This is schematically illustrated in FIGS. 6a and 6b in which a reasonably good fillet, with some height on the side element is possible from a low, closer to horizontal, angle, but a high closer to vertical angle makes a good fillet less available, and to alleviate this problem the injector would have to traverse more slowly and more glue would have to used.

It can then be appreciated that if the interior angle is less than 90°, the divergence of the angle of the injector from the midpoint angle toward horizontal is not likely to be affected to give a good glue fillet. But, the allowable divergence from the midpoint angle toward vertical is likely to considerably affected.

In an alternative method the side element may be slightly roughened where the glue will contact it. This will give a stronger bond. A knurling roller can be used to accomplish this roughening.

While there are shown and described certain specific embodiments of the invention for the purpose of clarity of understanding and to describe the embodiments preferred in order to meet the requirements of the description of the invention; it will be manifest to those skilled in the art that changes modifications and rearrangements of the features may be made without departing from the spirit and scope of the underlying inventive concept and concepts and that the present invention is not limited to the particular forms herein shown and described except insofar as allowed by the scope of the appended claims and equivalents thereof.

1. A method of making a candy box or a cover for a candy box comprising;
assembling onto a fixture a side member made of light weight paper board material in which a portion of the fixture is shaped to cause the side member to take on the desired shape and an inside surface of the side element defining an interior space and a portion of the fixture extends a distance into the interior space to leave a selected height of the side element extending above an upper face of the fixture;
placing into the interior space and onto the upper face of the fixture an inner closure element which is made of light weight paper board material and is shaped to conform to the shape of the inside surface of the side element and to fit substantially in contact with the side element the intersection of the side element and the inner closure element defining an interior corner;
directing around a substantial portion of the interior space a glue injector while injecting glue from the glue injector in a manner to leave a glue fillet in a substantial portion of the interior corner;
placing an outer closure element which is made of light weight paper board material over the inner closure element and applying only sufficient force to flatten the glue fillet between the inner and outer closure elements to a thickness that also leaves an area of glue contact with the inside surface of the side member; and
absent using any other structural element in contact with the glue to define the closure portion except use of the first and second closure elements.

2. The method of claim 1 wherein the injector is part of an automatic machine that controls movement of the glue injector and is programmed to maintain to the extent possible an angle of the glue injector for injection of the glue to provide a glue fillet in a substantial portion of the interior corner.

3. The method of claim 1 wherein the amount of glue injected is controlled to leave a glue layer after assembly and curing of the glue of a thickness of about twice the sum of the thickness of the inner closure element and the outer closure element.

4. The method of claim 1 in which the candy box or the candy box cover is heart shaped.

5. The method of claim 2 wherein the machine is a six axis machine for controlling movement of the glue injector.

6. The method of claim 2 wherein the angle of the glue injector is allowed to vary by ±about 20° from an angle that is ½ the interior angle.

7. The method of claim 2 in which the glue injection is begun at a point on the surface of the inner closure element away from the intersection of the side element and the inner closure element and is then directed into the interior corner.

8. The method of claim 3 wherein the amount of glue injected is controlled to leave a glue layer after assembly and curing of the glue of a width at least about twice the sum of the thickness of the inner closure element and the outer closure element.

9. The method of claim 3 wherein the amount of glue injected is controlled to leave a glue layer after assembly and curing of the glue of a width at least about three times the sum of the thickness of the inner closure element and the outer closure element.

10. The method of claim 3 wherein the injector is part of an automatic machine that controls movement of the glue injector and is programmed to maintain to the extent possible an angle of the glue injector for injection of the glue to provide a glue fillet in a substantial portion of the interior corner

11. The method of claim 7 in which the candy box or the candy box cover are heart shaped and the point at which glue injection is begun is near the point of the heart the heart and the injection of glue is terminated a selected distance away from the point of the heart.

12. The method of claim 10 wherein the machine is a six axis machine.

13. The method of claim 10 wherein the angle for injection is allowed to vary by ±about 20°.

14. The method of claim 13 wherein the angle for injection is allowed to vary by ±about 10°.

15. A candy box or a cover for a candy box comprising;
a side member made of light weight paper board material shaped to have a desired shape and an inside surface of the side element defining an interior space;
in the interior space an inner closure element which is made of light weight paper board material and is shaped to conform to the shape of the inside surface of the side element and to fit substantially in contact with the side element the intersection of the side element and the inner closure element defining an interior corner;
a glue fillet in a substantial portion of the interior corner;
an outer closure element which is made of light weight paper board material applied over the inner closure element to flatten the glue fillet between the inner and outer closure elements to a glue layer with a thickness that also leaves an area of glue contact with the inside surface of the side member; and
absent any other structural element in contact with the glue to define the closure portion except the first and second closure elements.

16. The candy box or a cover for a candy box of claims 15 further comprising;
the glue layer having a thickness of about twice the sum of the thicknesses of the inner closure element and the outer closure element.

17. The candy box or a cover for a candy box of claims 15 further wherein;
the candy box or candy box cover is heart shaped.
